(19) United States
(12) Patent Application Publication
(10) Pub. No.: US 2011/0238570 A1
(43) Pub. Date: Sep. 29, 2011

(54) System of Online Trading Through Intermediary Platform and Methods Thereof

(75) Inventors: Shanfa Li, Hangzhou (CN); Xufang Kong, Hangzhou (CN)

(73) Assignee: ALIBABA GROUP HOLDING LIMITED, Grand Cayman (unknown)

(21) Appl. No.: 12/863,647

(22) PCT Filed: Nov. 19, 2009
(86) PCT No.: PCT/US09/65158

§ 371 Date: Jul. 20, 2010

(30) Foreign Application Priority Data
Dec. 15, 2008 (CN) 200810182976.X

(51) Int. Cl. G06Q 40/00

(52) U.S. Cl. 705/40

(57) ABSTRACT

System and methods of conducting an online transaction through an intermediary platform are provided. In one aspect, a system of conducting online transactions comprises an intermediary platform that includes an intermediary platform server and an intermediary platform database. The intermediary platform server includes a synchronous processing unit that receives information of a product from a merchant selling the product causes the information of the product of the merchant to be displayed at a predetermined linked position in a user interface. The intermediary platform server also includes a transaction request processing unit that receives a transaction request to purchase the product from a user, sends the transaction request to the merchant, and receives a transaction result from the merchant. The intermediary platform server further includes an interaction unit that establishes communications with the merchant and the user. The intermediary platform database includes a merchant information storage unit that stores contact information of the merchant and a correlation between the information of the product of the merchant and the merchant. The intermediary platform database also includes a transaction information storage unit that stores information of a transaction, which includes one or more of merchant information, user information, product information, transaction result information of the transaction, or a combination thereof.

### RELATED APPLICATIONS

This application is a national stage application of international patent application PCT/US09/65158, filed Nov. 19, 2009 entitled “SYSTEM OF ONLINE TRADING THROUGH INTERMEDIARY PLATFORM AND METHODS THEREOF” claiming priority from Chinese patent application, Application No. 200810182976.X, filed Dec. 15, 2008, entitled “SYSTEM OF ONLINE TRADING THROUGH INTERMEDIARY PLATFORM AND METHODS THEREOF”, which are hereby incorporated in their entirety by reference.

### TECHNICAL FIELD

The present disclosure is generally directed to networking and, more particularly, to online e-commerce trading systems and methods that are related to cost-per-sale (CPS) shopping platforms.

### BACKGROUND

With the development of the Internet and maturity of encryption technologies such as digital signature, the reach of electronic commerce, or e-commerce, has been expanding globally at a tremendous pace. Many successful companies have their primary business models based on e-commerce, including Amazon.com and Alibaba.com.

This kind of business method has completely revolutionized the existing business mode. FIG. 1 illustrates a commonly seen example of an existing online trading system 100. The system 100 includes merchants 1a and 1b, an intermediary platform 2, a payment platform 3, and users 4a and 4b. The user 4a purchases a product of the merchant 1a by making an online payment through the payment platform 3. The merchant 1a ships the product to the user 4a by mailing for example. The merchant 1a and the payment platform 3 conduct account reconciliation and account remittance on a regular basis. Of course, functions that are performed by the payment platform 3 can be integrated in the intermediary platform 2.

An example of the payment platform 3 is AliPay, an online payment services provider. The user 4a may open an account with AliPay, and deposit a certain amount of funds in the account by direct deposit or periodic recharges. Accordingly, when the user 4a purchases a product of the merchant 1a, a deduction from the account of the user 4a is processed through AliPay to consummate the sale of the product. Under such scheme, the merchant 1a needs only to complete account reconciliation and account remittance with AliPay on a regular basis.

An example of the intermediary platform 2 is TaoBao.com, an online auction site. The user 4a purchases a product of the merchant 1a through TaoBao.com. The intermediary platform 2 includes at least a server center 11 and a database 12. The server center 11 is used for processing each transaction request, while the database 12 is used for recording each transaction in real time.

As illustrated in FIG. 1, the security of the transaction between the merchant 1a and the user 4a is greatly improved with the transaction going through the intermediary platform 2. From the perspective of a user, making a payment through a payment platform removes worries arising from the uncertainty of the authenticity of a merchant (because the merchant is an online virtual merchant), and the inability to assess the quality of a product to be purchased. From the perspective of a merchant, a user's worries can be relieved by establishing confidence of the user through the intermediary platform, thus improving sales volume. This type of business model achieves a multi-win situation for the merchant, the user and the intermediary platform provider, and has rapidly been developed and adopted recently.

FIG. 2 illustrates another commonly seen example of an existing online trading system 200. The user 4a purchases product(s) by logging onto various intermediary platforms, such as the first intermediary platform 5 . . . and the N^{th} intermediary platform 6, and makes respective payments through the payment platform 3. The payment platform 3 can conduct account reconciliation with the intermediary platforms while the intermediary platforms conduct account reconciliation with various merchants. Alternatively, the payment platform 3 can directly conduct account reconciliation with the merchants. Moreover, the user 4a can log onto merchant website 7, which has a contractual relationship with the payment platform 3, to purchase product(s) directly. If the user 4a makes a payment through the payment platform 3, the merchant website 7 can conduct account reconciliation with the payment platform 3 directly.

To attract users to purchase a product, a merchant sometimes sells the product at a discount. The merchant posts information of the discounted product on its website. To increase sales channels, the merchant further posts information of the discounted product on an intermediary platform. However, situations such as inconsistencies between information of a discounted product posted on the merchant website and that posted on the intermediary platform exist in current business model, thus affecting a transaction and even reputation of the merchant.

From the perspective of a network, the following deficiencies primarily exist:

(1) Existing trading methods generally have the following problem: In order to increase sales volume of a discounted product, a merchant generally links information of the discounted product to a number of websites. When such information of the discounted product changes for whatever reason, respective information of the discounted product on those linked websites might not be updated timely, and this could undesirably lead to a number of unforeseen events during a transaction process. From the perspective of the entire network, the need to update information of discounted products unnecessarily increases the burden of data transmission and consumes data storage space in the network.

(2) The existence of various registered names and passwords for various websites in the course of online transactions tend to result in excessive waste of data storage space in the websites as well as manpower and resources for maintenance. Generally, the transaction website which holds the information of the discounted product, the transaction platform, and even the merchant website, each requires respective username and password for a user to log on. This requires a user to memorize a large number of usernames and passwords and, unfortunately, may easily hinder the progress of a transaction due to oblivescence. From the perspective of a website, the need for human maintenance for a large amount of data storage space undesirably leads to a cost increase.

(3) A consumer is sensitive to prices and desires to purchase a product having a good cost performance ratio, especially in the case of a discounted brand-name product. However, due to limitations of geographical distance and source of information, such desire cannot always be fulfilled in real life. Although the Internet provides advantages in terms of information transparency and elimination of obstacle due to geographical distance, there has yet to be an online platform that is suitable for online trading of discounted products.

### SUMMARY

A goal of the present disclosure is to provide a system of conducting an online transaction through an intermediary platform for online transactions associated with discounted products.

Another goal of the present disclosure is to provide a method of conducting an online transaction through an intermediary platform for online transactions associated with discounted products.

In order to achieve the aforementioned goals, in one aspect, the disclosed system of conducting an online transaction through an intermediary platform according to one embodiment may include a user, a payment platform, and a merchant connected through a network, such as the Internet for example. The system may further include an intermediary platform that provides information of a discounted product of a merchant. The intermediary platform may be connected to the network and, in one embodiment, may include an intermediary platform server and an intermediary platform database.

The intermediary platform server may include a synchronous processing unit, a transaction request processing unit, and an interaction unit. The synchronous processing unit may be used for receiving uploaded or modified information of a discounted product that is provided by the merchant, and for displaying the information of the discounted product of the merchant at predetermined linked position(s). The transaction request processing unit may be used for receiving a transaction request for purchasing the discounted product from the merchant, sending the transaction request to the merchant corresponding to the discounted product, and receiving a returned transaction result. The interaction unit may be used for establishing interaction with external devices including external devices of the merchant and the user.

The intermediary platform database may include a merchant information storage unit and a transaction information storage unit. The merchant information storage unit may be used for storing address information of each merchant and a correspondence relationship between the information of the discounted product and its corresponding merchant. The transaction information storage unit may be used for storing transaction information of each transaction including merchant information, user information, product information, and transaction result information of the transaction.

The merchant may include a transaction request receiving unit, which may be used for receiving a transaction request sent from the intermediary platform, obtaining information of the product to be purchased by the user as well as user information, and sending associated transaction information to the payment platform for completing subsequent product shipment according to a transaction result returned from the payment platform.

The payment platform may include a payment platform server and a payment platform database. The payment platform server may include at least a user processing unit, which may be used for receiving user identity requests having user registration and user login. The payment platform database may include at least a user information storage unit, which may be used for storing the correlations among various pieces of user-related information including a username and a password associated with user registration, user identity information, user address, and a payment account of the user.

The intermediary platform server of the intermediary platform may further include a payment platform registered user processing unit, which may be used for receiving a user request for logging onto the intermediary platform with a username registered in the payment platform, sending the request to the payment platform, and permitting the user's login upon successful verification by the payment platform.

The merchant may further include a payment platform registered user transaction processing unit, which may be communicatively coupled to the transaction request receiving unit and may be used for linking information of a registered user of the payment platform that has been parsed out by the transaction request receiving unit to corresponding user-related information obtained by the payment platform.

The intermediary platform server may further include a payment platform processing unit, which may be communicatively coupled to the transaction request processing unit and may be used for sending transaction request information to the payment platform and receiving a payment feedback returned from the payment platform.

The payment platform server may further include an intermediary platform transaction request processing unit, which may be used for receiving a transaction request from the intermediary platform, recognizing the same transaction request from the merchant through a serial trading number, and sending the transaction result to the intermediary platform either through the merchant or directly from the payment platform server.

The payment platform server may further include a profit-sharing unit, which is used for periodically completing profit-sharing operations with various intermediary platforms according to predetermined profit-sharing setting(s).

In another aspect, a method of conducting an online transaction through an intermediary platform includes a user, a payment platform, and a merchant connected to the intermediary platform through a network, such as the Internet for example. The method includes a number of actions as follows:

(1) An intermediary platform is established to link another intermediary platform or a merchant having a contractual relationship with the established intermediary platform.

(2) The merchant or the intermediary platform synchronizes information of a discounted product therein with the established intermediary platform, which displays the discounted product information at predetermined linked position(s).

(3) Upon receiving a transaction request from a user, the established intermediary platform sends the transaction request and the user information to each relevant merchant.

(4) The merchant creates a purchase order and sends the order to the payment platform.

(5) The payment platform consummates payment by the user, returns a payment result to the merchant, and sends the payment result to the intermediary platform either through the merchant or directly.

(6) The merchant completes product shipment based on the returned payment result.

Upon receiving from a user a request of logging onto the intermediary platform using a username registered in the payment platform, the intermediary platform may send the request to the payment platform and permit the user's login only upon successful verification by the payment platform. When sending a transaction request to a relevant merchant, the intermediary platform may also include information of the username of the user in the transaction request. Upon receiving the transaction request, the merchant may reckon the information of the username registered in the payment platform (that has been parsed out and stored therein) to be user information for the merchant. The merchant may create a purchase order which includes the information of the username of the user that is registered in the payment platform. The payment result received by the merchant may contain user information including a shipping address of the user for the merchant to complete delivery of the product.

In one aspect, when an intermediary platform sends a transaction request to a merchant, the transaction request includes a serial trading number. The intermediary platform also sends a payment platform the transaction request with the serial trading number. The payment platform identifies the corresponding transaction based on the serial trading number and separately sends a payment result of the corresponding transaction to the merchant and the intermediary platform. The payment platform also completes profit sharing with the intermediary platform according to a profit-sharing ratio.

In another aspect of a system of conducting an online transaction through an intermediary platform in which a user, a payment platform, and a merchant are connected through a network such as the Internet, the system also includes an intermediary platform that provides information of discounted products to customers. The intermediary platform is communicatively coupled to the Internet and includes an intermediary platform server and an intermediary platform database.

The intermediary platform server may include a synchronization processing unit, a transaction request processing unit, a payment platform processing unit, a merchant processing unit, and an interaction unit. The synchronization processing unit may be used for receiving uploaded or modified discounted product information provided by the merchant and displaying the discounted product information from the merchant at predetermined linked position(s). The transaction request processing unit may be used for receiving a transaction request for purchasing a discounted product from the user and creating a purchase order. The payment platform processing unit may be used for sending the purchase order to the payment platform and receiving a payment result from the payment platform. The merchant processing unit may be communicatively coupled to the payment platform processing unit, and used for sending a transaction message of successful payment, or a payment result, to the merchant which then completes product shipment. The interaction unit may be used for establishing interaction with external devices including external devices of the merchant and the user.

The intermediary platform database may include a merchant information storage unit and a transaction information storage unit. The merchant information storage unit may be used for storing merchant address information for linking to the merchant and a correlation between the discounted product information of the merchant and the merchant. The transaction information storage unit may be used for storing transaction information of each transaction, which includes merchant information, user information, product information, and transaction result information that are associated with the transaction.

The merchant may include a transaction request receiving unit, which may be used for receiving the transaction message of successful payment sent from the intermediary platform to obtain information of the product purchased by the user as well as user information for completion of subsequent product shipment.

The payment platform may include a payment platform server and a payment platform database. The payment platform server may include at least a user processing unit, which is used for receiving user identity requests including user registration and user login. The payment platform database may include at least a user information storage unit, which is used for storing the correlations among various user-related information including a username and a password associated with user registration, user identity information, a user address and a payment account of the user.

The intermediary platform server of the intermediary platform may further include a payment platform registered user processing unit, which may be used for receiving a request of logging onto the intermediary platform using a username registered in the payment platform from the user, sending the request to the payment platform, and permitting the user's login upon successful verification by the payment platform.

The payment platform server may further include a profit-sharing unit, which may be used for completing profit sharing with various intermediary platforms according to predetermined profit-sharing setting(s).

In a further aspect, a second method of conducting an online transaction through an intermediary platform includes a user, a payment platform, and a merchant connected to the intermediary platform through a network, such as the Internet for example. The method includes a number of actions as follows:

(1) An intermediary platform is established to link another intermediary platform or a merchant having a contractual relationship with the established intermediary platform.

(2) The merchant or the intermediary platform synchronizes information of a discounted product therein with the established intermediary platform, which displays the discounted product information at predetermined linked position(s).

(3) Upon receiving a transaction request from a user, the established intermediary platform creates a purchase order that includes the transaction request and user information and sends the purchase order to a payment platform.

(4) The payment platform completes a payment made by the user and returns a payment result to the established intermediary platform.

(5) The established intermediary platform returns a transaction message of successful payment to the relevant merchant which then completes product shipment based on the returned payment result.

The present disclosure provides an online trading method that is based on an intermediary platform that facilitates online shopping for consumers, or users, and adds a new sales channel for merchants.

From a technical point of view, embodiments of the disclosed systems and methods have a number of advantages. Firstly, the present disclosure provides an intermediary platform. A merchant may place discounted product information in the intermediary platform on a regular basis or on an event-triggered basis, thus ensuring timeliness of accessibility of the discounted product information on the intermediary platform. A user only needs to log onto the intermediary platform to obtain a huge amount of latest discount information from one or more merchants. From the perspective of an entire network, various discount information can be effectively managed to provide convenience to users and merchants and avoid the need of a large amount of data storage space. Success rate of data transaction is also improved at the same time. Secondly, the present disclosure provides two types of trading models: one type utilizes an intermediary platform merely as a display platform while the other type utilizes an intermediary platform as both a display platform and a trading platform. Regardless of which model is used, resources can be effectively allocated and used from the perspective of an entire network. Thirdly, the present disclosure only requires using a username and a password associated with a payment platform to achieve login and various operations associated with the intermediary platform or with the intermediary platform and a merchant website. This resolves the problem of a user having to memorize or keep track of a large number of usernames and passwords. Of course, it will be understood that any implementation of the disclosed systems and methods needs not to achieve all the above advantages at the same time.

### DESCRIPTION OF DRAWINGS

FIG. 1 shows a diagram of a commonly seen example of existing online trading systems.

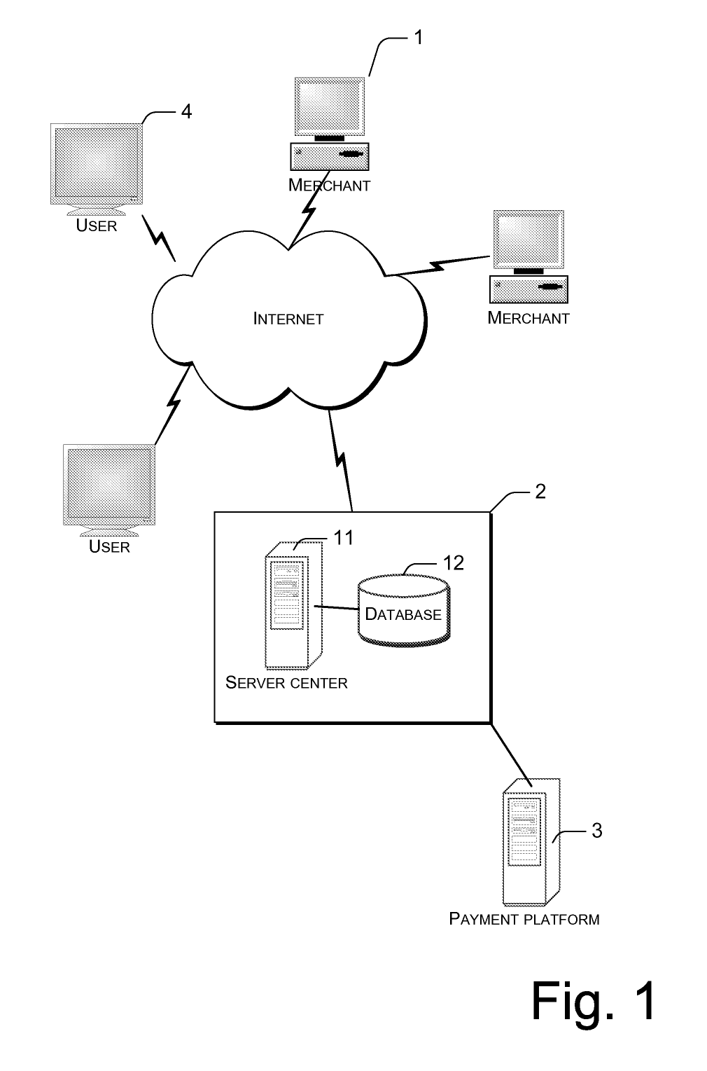

FIG. 2 shows a diagram of another commonly seen example of existing online trading systems.

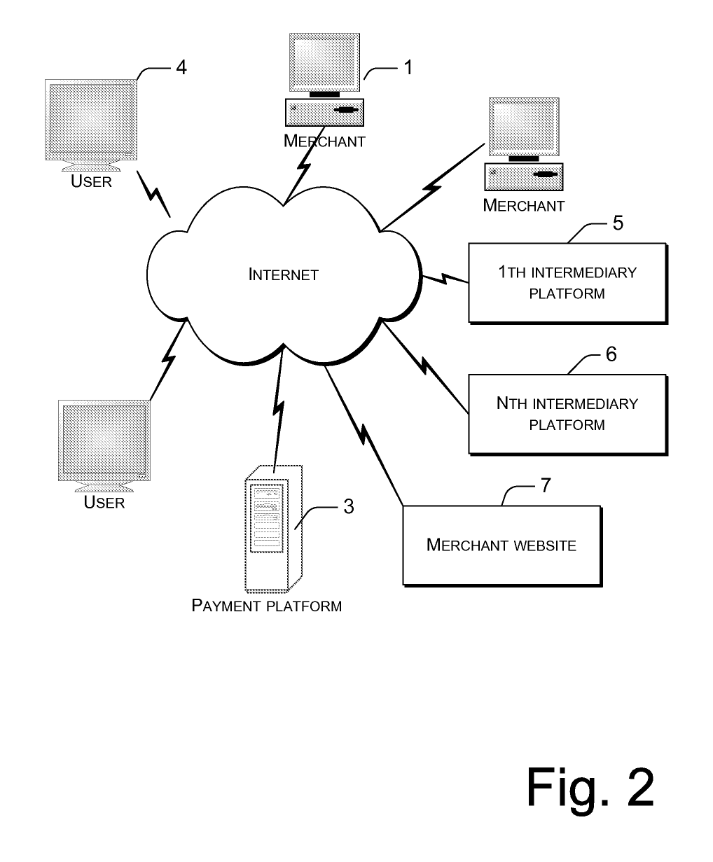

FIG. 3 shows a diagram of a first exemplary system of conducting an online transaction through an intermediary platform in accordance with an embodiment.

FIG. 4 shows a flow chart of a first exemplary method of conducting an online transaction through an intermediary platform in accordance with an embodiment.

FIG. 5 shows a diagram of a second exemplary system of conducting an online transaction through an intermediary platform in accordance with another embodiment.

FIG. 6 shows a flow chart of a second exemplary method of conducting an online transaction through an intermediary platform in accordance with another embodiment.

### DETAILED DESCRIPTION

The present disclosure is described in details below with reference to the accompanying figures.

The core idea in the present disclosure relates to the use of an intermediary platform in an online trading system. In one embodiment, the intermediary platform allows placement of product information by various merchants, receives purchase requests from users, and links to relevant merchants for completion of associated transactions. Alternatively, the intermediary platform directly completes the transactions through a payment platform. Moreover, in one embodiment, a purchase request may be completed using a registered username in the payment platform. As such, the users can complete logins and purchases without going through registration when making respective purchases through the intermediary platform. Furthermore, the intermediary platform may have agreed in advance a profit-sharing ratio with the payment platform. The payment platform may then regularly perform profit-sharing operations with various intermediary platforms according to the profit-sharing ratio. Generally, the intermediary platform may alternatively be called a cost-per-sale platform, or a CPS platform. The CPS platform may be an existing intermediary platform (e.g., a part of a shopping website) or another intermediary platform that is separate from an existing shopping website.

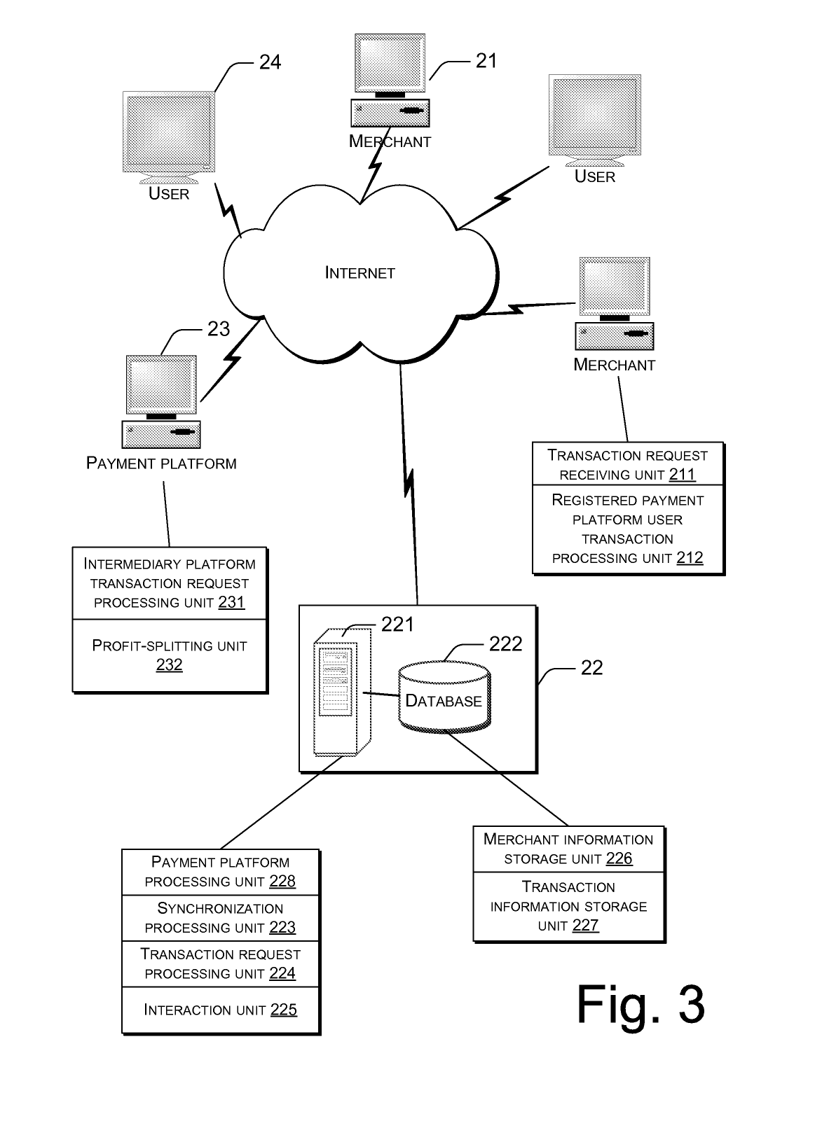

FIG. 3 illustrates a system 300 of conducting an online transaction through an intermediary platform in accordance with an embodiment. The system 300 includes users 24a and 24b, a payment platform 23, and merchants 21a and 21b, all of which are connected through the network 25.

The system 300 further includes one or more intermediary platform 22 that is used for providing discounted product information to customers such as the users 24a and 24b. The intermediary platform 22 is a node in the network 25 and may be visited by the users 24a and 24b. In some embodiments, the intermediary platform 22 may be a local area network or simply a single terminal computer. In other embodiments, the intermediary platform 22 may be provided by the payment platform 23 or by other platforms. In yet another embodiment, the intermediary platform 22 may be a merchant website.

In one embodiment, the intermediary platform 22 is communicatively coupled to the network 25 and includes an intermediary platform server 221 and an intermediary platform database 222.

The intermediary platform server 221 includes a synchronization processing unit 223, a transaction request processing unit 224, and an interaction unit 225. The synchronization processing unit 223 receives uploaded or modified discounted product information that is provided by the merchants 21a and 21b on a regular basis or on an event-triggered basis. The synchronization processing unit 223 displays the discounted product information from the merchants 21a and 21b at a predetermined linked position(s). The transaction request processing unit 224 receives a transaction request for purchasing discounted product(s) from the user 24a or 24b, sends the transaction request to each merchant 21a, 21b that is corresponding to the discounted product(s) to be purchased, and receives returned transaction result(s). The interaction unit 225 establishes interaction with external devices including external devices of the merchants 21a and 21b and the users 24a and 24b.

The intermediary platform database 222 includes a merchant information storage unit 226 and a transaction information storage unit 227. The merchant information storage unit 226 stores merchant address information that links to the merchants 21a, 21b and a correlation between the discounted product information and the respective merchant 21a or 21b. The transaction information storage unit 227 stores transaction information of each transaction, which includes merchant information, user information, product information, and transaction result information that are associated with the transaction.

In some embodiments, the synchronization processing 223 and the transaction request processing unit 224 are logical units and are implemented in software. Alternatively, they can be implemented in hardware in the form of a server or a processor of a server.

In one embodiment, the merchant 21 includes an intermediary platform handling software, for example, installed on a processor. In another embodiment, a transaction request receiving unit 211 is further included and is used for receiving a transaction request sent from the intermediary platform 22, obtaining information of product(s) to be purchased by the user 24 as well as user information, and sending associated transaction information to the payment platform 23, for completing subsequent product shipment according to a transaction result returned from the payment platform 23.

A transaction can be completed directly on an existing payment platform 23. Alternatively, software in an existing payment platform 23 may be upgraded to support an online transaction that is based on an intermediary platform.

In one embodiment, completion of an entire online transaction can be achieved using registration information of the user 24 in the payment platform, thereby avoiding the user 24 from requiring registration in the intermediary platform 22 and a website of the merchant 21. The payment platform 23 includes a payment platform server and a payment platform database. The payment platform server includes at least a user processing unit, which is used for receiving user identity requests including user registration and user login. The payment platform database includes at least a user information storage unit, which is used for storing correspondence relationships among various user characteristics information including a username and a password associated with user registration, user identity information, a user address and a payment account of the user.

In one embodiment, the user processing unit is implemented in software while the user information storage unit is a storage unit in a database. The storage unit is defined from a logical point of view, and needs not be limited to a single physical storage space. Specifically, based on existing storage technology, the user information storage unit may include a piece of consecutive storage space in one embodiment or unconnected storage spaces in the database in an alternative embodiment. Similarly, a storage unit in a database in the present disclosure is defined according to a logical point of view but is not limited to a single physical storage space.

In one embodiment, the intermediary platform server 221 of the intermediary platform 22 further includes a registered payment platform user processing unit, which is used for receiving a request for logging onto the intermediary platform 22 using a username registered in the payment platform 23 from the user 24, for example, receiving a request of logging using a username registered in the payment platform 23 from the user 24, sending the request to the payment platform 23, and permitting login by the user 24 upon successful verification by the payment platform 23. In one embodiment, the merchant 21 includes a registered payment platform user transaction processing unit 212, which is communicatively coupled with the transaction request receiving unit 211 and is used for linking registered user information in the payment platform 24 which has been parsed out by the transaction request receiving unit 211 to relevant user-related information obtained by the payment platform 23.

It should be noted that the merchant 21 and the intermediary platform 22 may be independent user registration systems. Specifically, prior to logging onto the intermediary platform 22, the user 24 may need to register to become a registered user of the intermediary platform 22 in advance. After the intermediary platform 22 sends transaction request information to relevant merchant 21, the merchant 21 first determines whether the user 24 is a registered user thereof. If the user 24 is a registered user, the merchant 21 processes the transaction request information. Otherwise, the merchant 21 first requires the user 24 to register to become a registered user of the merchant 21. One preferred embodiment of the present disclosure is to set up a registered payment platform user processing unit in the intermediary platform server 221 and a registered payment platform user transaction processing unit 212 in the merchant 21 as described above.

In one embodiment, the intermediary platform server 221 further includes a payment platform processing unit 228, which is communicatively coupled with the transaction request processing unit 224 and is used for sending transaction request information to the payment platform 23 and receiving a payment feedback returned from the payment platform 23. In one embodiment, the payment platform 23 includes an intermediary platform transaction request processing unit 231, which is used for receiving a transaction request from the intermediary platform 22, recognizing the same transaction request sent from the merchant 24 through a serial trading number, and sending a transaction result to the intermediary platform 22 either through the merchant 21 or directly from the payment platform 23.

The transaction request information sent by the payment platform processing unit 228 includes a serial trading number, and is determined by the intermediary platform transaction request processing unit 231 to be the same transaction request or not based on the serial trading number. The serial trading number may have been agreed upon in advance by the intermediary platform 22 and the payment platform 23. For example, a serial trading number may have N1 number of bits with the first N2 bits being a characteristic number of the intermediary platform, and bits between the N3^{th} bit and the N4^{th} bit being transaction-related information such as a transaction time. The intermediary platform transaction request processing unit 231 may store transaction information for different intermediary platforms 22 and according to different periodic time cycles. In one embodiment, the payment platform 23 further includes a profit-sharing unit 232, which is used for completing profit sharing with various intermediary platforms 22 according to predetermined profit-sharing setting(s).

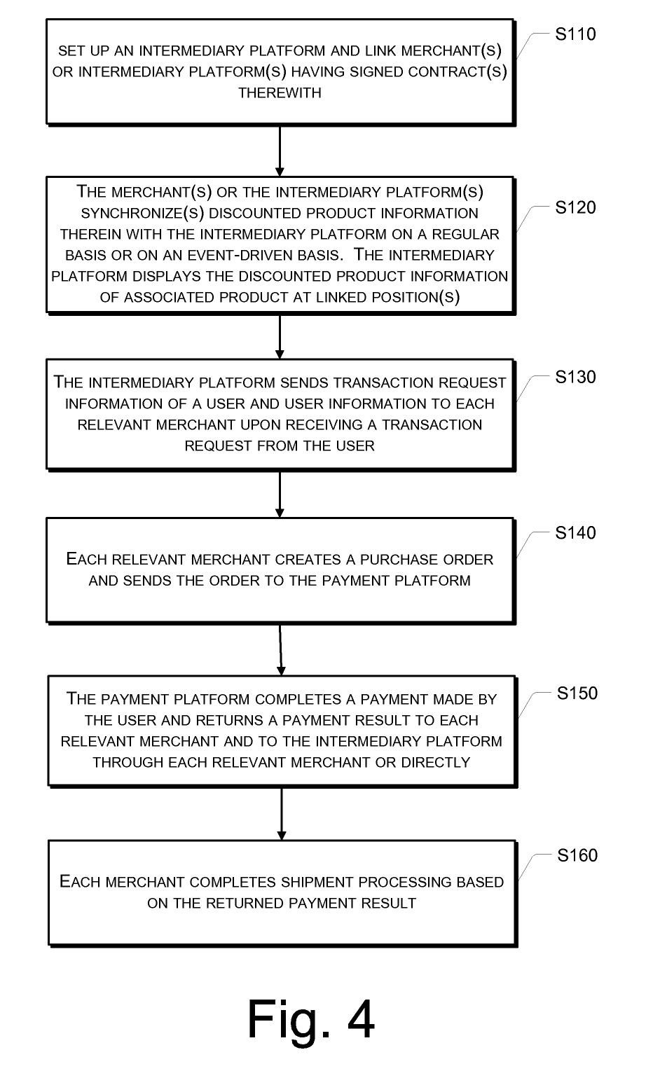

FIG. 4 shows a flow chart of a first exemplary method 400 of conducting an online transaction through an intermediary platform. This method is suitable for use in an online transaction platform that is connected with a user, a payment platform and a merchant through a network such as the Internet.

At block S110, an intermediary platform is provided, and link between the intermediary platform and merchants with which a contractual relationship exists is established. The intermediary platform may also be linked to other preexisting intermediary platforms.

In one embodiment, an intermediary platform similar to a merchant website is set up in advance, with the intermediary platform being a node in the Internet. In a preferred embodiment, the intermediary platform is provided by a payment platform. In this way, the intermediary platform can utilize existing resources of the payment platform, e.g., customer resources. In another preferred embodiment, the intermediary platform is provided by another preexisting intermediary platform, such as TaoBao.com or DangDang.com. As such, the intermediary platform can utilize the resources of the preexisting intermediary platform, e.g., merchant resources.

At block S120, a merchant or a preexisting intermediary platform linked to the intermediary platform synchronizes with the intermediary platform with respect to product discount information, and the intermediary platform displays the product discount information at predetermined linked position(s).

In one embodiment, the merchant or the preexisting intermediary platform may enter into a contractual relationship with the intermediary platform which records information of the merchant or the preexisting intermediary platform. If the intermediary platform is provided by a payment platform, then the merchant or the preexisting intermediary platform can be a registered user of the payment platform, and the agreed-upon contract can include transaction information such as, for example, a profit-sharing ratio.

In one embodiment, the merchant or the preexisting intermediary platform updates its product discount information displayed by the intermediary platform on a regular basis, e.g., daily or weekly. Alternatively, the update may be triggered by an event, e.g., when the price of a new product is discounted. By sending product discount information to the intermediary platform to be displayed in such fashion, the merchant or the preexisting intermediary platform can provide the most current product discount information for access by users at predetermined linked position(s). In one embodiment, the intermediary platform displays the product discount information at web address(es) agreed upon with the merchant. Alternatively, the product discount information may be displayed at predetermined web address(es) according to an order that such information is received and stored by the intermediary platform, for example. In one embodiment, the merchant or the preexisting intermediary platform synchronizes additions and/or modifications to the product discount information with the intermediary platform. In one embodiment, the product discount information includes a product name, a product price, and beginning and ending times of associated discount.

At block S130, upon receiving a transaction request from a user, the intermediary platform forwards the transaction request and information of the user to each relevant merchant.

In one embodiment, a user needs to first register to become a registered user of the intermediary platform before logging onto the intermediary platform. In another embodiment, a user of the intermediary platform can be a registered user of a payment platform. If the user is a registered user of a payment platform, the intermediary platform forwards login information of the user to the payment platform when the user attempts to log onto the intermediary platform. The user is only allowed to log onto the intermediary platform upon successful verification of the user's identity by the payment platform.

For each product a user sends a transaction request to purchase, the intermediary platform sends the transaction request to the relevant merchant. For example, a user may send to the intermediary platform transaction requests for the purchase of two discounted products. If these two discounted products belong to the same merchant, the intermediary platform forwards the transaction requests to that merchant. The transaction request includes information of the discounted products to be purchased (e.g., product serial number and price) and user information. If the user is a registered user of a payment platform, information such as a username of the user registered with the payment platform is sent to the relevant merchant along with the information of the discounted products. If the two discounted products belong to two different merchants, the intermediary platform correspondingly forwards each transaction request, along with the user information, to the respective one of the two merchants.

At block S140, the merchant generates a purchase order and sends the purchase order to the payment platform.

In one embodiment, upon receiving the transaction request, the merchant generates a purchase order and sends the purchase order to the payment platform. The purchase order includes, for example, user information and purchase information.

At block S150, the payment platform completes a payment made by the user, and returns payment result to the merchant and to the intermediary platform either through the merchant or directly to the intermediary platform.

In one embodiment, upon receiving a purchase order, the payment platform parses out the user information from the purchase order. If the user is determined to be a registered user of the payment platform, information of the user (including, for example, user identity information, a previous delivery address of the user, a user purchase record and a payment record of the user) is obtained from the database of the payment platform for processing the payment. If the user's account has sufficient funds, the payment is processed. If, however there is insufficient fund, the user is notified to recharge the user's account before the payment can be processed. Because the payment process is well known in the art, details thereof are not repeated herein in the interest of brevity.

As the payment platform returns the payment result, such as successful completion of payment for example, to the merchant, the merchant proceeds to send the purchased product to the user's delivery address. In one embodiment, the payment result is returned to the intermediary platform from the payment platform. Alternatively, the payment result is returned to the intermediary platform via the merchant.

At block S160, the merchant completes shipment process based on the payment result.

The can be various scenarios related to user login. In one embodiment, a user registers a new username with the intermediary platform or uses a registered username of the payment platform to log onto the intermediary platform. Alternatively, the user registers a new username with the merchant, uses a username registered with the payment platform, or uses a username registered with the intermediary platform to log onto the merchant website. In one embodiment, logging onto the intermediary platform and various merchant websites is performed using a username registered with the payment platform in order to achieve the advantage of allowing user login without requiring registration with each merchant and intermediary platform, thus providing convenience for the user. This also greatly reduces the waste of storage space and improves security of online transactions.

In one embodiment, when the intermediary platform receives from a user a login request that uses a username registered with the payment platform, the intermediary platform sends the request to the payment platform and allows the user's login upon successful verification by the payment platform. The intermediary platform sends a transaction request to a relevant merchant with the transaction request including the user's username that is registered with the payment platform. After the merchant receives the transaction request, of the username registered with the payment platform is parsed out and stored by the merchant. The merchant creates a purchase order which includes the username of the user that is registered with the payment platform. Upon receiving a payment result, the merchant completes product delivery using the user information (which includes a shipping address of the user) obtained from the payment result.

In one embodiment, the intermediary platform directly communicates with various merchants and directly negotiates profit-sharing ratios with other intermediary platforms without going through the payment platform directly. Alternatively, the intermediary platform directly communicates with the payment platform and negotiates a profit-sharing ratio with the payment platform. When a transaction request is sent from the intermediary platform to a merchant, the transaction request includes a serial trading number. The intermediary platform also sends to the payment platform a transaction request which includes the serial trading number. The payment platform determines the same transaction information based on the serial trading number and sends payment result of the transaction to the merchant and the intermediary platform. Afterwards, the payment platform completes profit-sharing operation with the intermediary platform according to the profit-sharing ratio.

The intermediary platform described above is similar to a merchant that merely provides a display function and does not participate in a transaction. In other embodiments, the transaction is conducted directly through a payment platform.

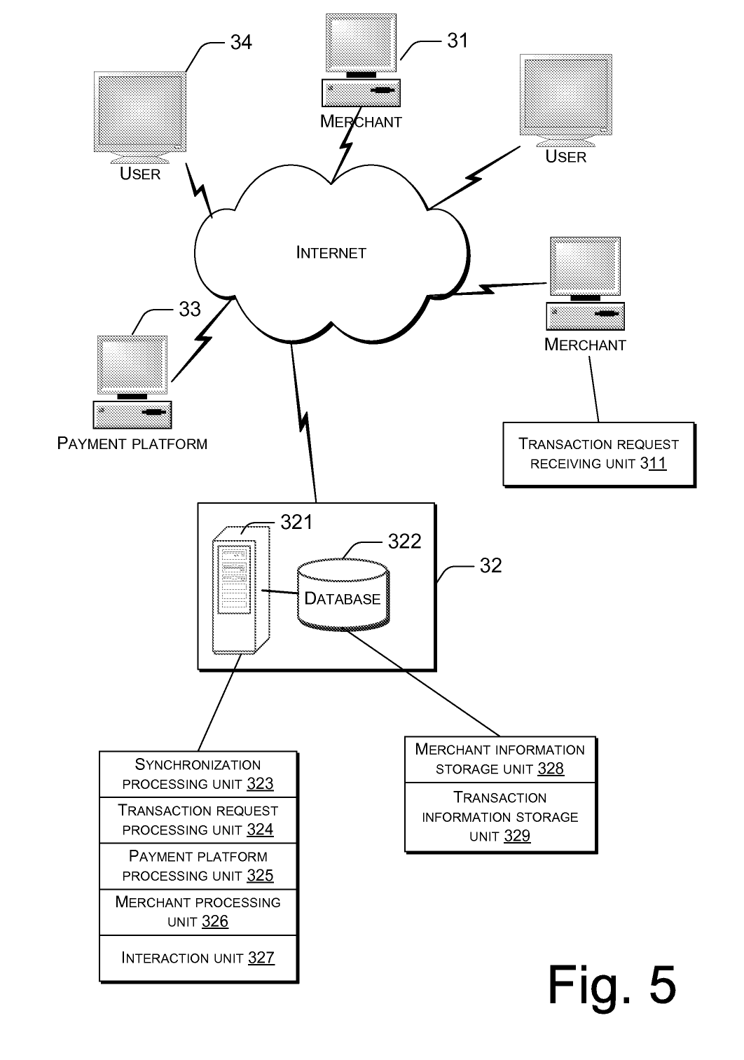

FIG. 5 shows a schematic structural diagram of a second exemplary system 500 of conducting an online transaction through an intermediary platform. The system 500 includes users 34a and 34b, payment platform 33, and merchants 31a and 31b. The users 34a and 34b, the payment platform 33, and the merchants 31a and 31b are connected through the network 35, such as the Internet for example.

The system 500 further includes an intermediary platform 32 that provides product discount information to customers. The intermediary platform 32 is connected to the network 35 and includes an intermediary platform server 321 and an intermediary platform database 322.

In one embodiment, the intermediary platform server 321 includes a synchronization processing unit 323, a transaction request processing unit 324, a payment platform processing unit 325, a merchant processing unit 326, and an interaction unit 327. The synchronization processing unit 323 is used for receiving uploaded or modified product discount information provided by the merchant 31a or 31b on a regular basis or on an event-triggered basis, and for displaying the product discount information of the merchant 31a or 31b at one or more predetermined linked positions. The transaction request processing unit 324 is used for receiving a transaction request for purchase of discounted product(s) from the user 34a or 34b, and for creating a purchase order. The payment platform processing unit 325 is used for sending the purchase order to the payment platform 33 and receiving a payment result from the payment platform 33. The merchant processing unit 326, which is communicatively coupled with the payment platform processing unit 325, is used for sending a transaction message of successful payment to the merchant 31a or 31b which then completes shipment. The interaction unit 327 is used for establishing interaction with external devices including external devices of the merchant 31a and 31b and the user 34a and 34b.

In one embodiment, the intermediary platform database 322 includes a merchant information storage unit 328 and a transaction information storage unit 329. The merchant information storage unit 328 is used for storing merchant address information that links to the merchant 31a or 31b and a correlation between the product discount information and the merchant 31a or 31b. The transaction information storage unit 329 is used for storing transaction information of each transaction, which includes, for example, merchant information, user information, product information and transaction result information that are associated with the transaction.

In one embodiment, the merchant 31a includes a transaction request receiving unit 311, which is used for receiving the transaction message of successful payment from the intermediary platform 32, obtaining information of product(s) to be purchased by the user 34a or 34b as well as user information, and completing subsequent shipment.

In one embodiment, the payment platform 33 includes a payment platform server and a payment platform database. The payment platform server includes at least a user processing unit, which is used for receiving user identity requests including user registration and user login. The payment platform database includes at least a user information storage unit, which is used for storing correlations among various user-related information including usernames and passwords associated with user registration, user identity information, user addresses and the payment account of each registered user. In one embodiment, the intermediary platform server 321 of the intermediary platform 32 further includes a registered payment platform user processing unit, which is used for receiving a request for logging onto the intermediary platform 32 using a username registered with the payment platform 33 from the user 34a or 34b, sending the request to the payment platform 33, and permitting login upon successful verification by the payment platform 33.

In one embodiment, the payment platform server further includes a profit-sharing unit, which is used for completing profit sharing with the intermediary platform 32 according to predetermined profit-sharing setting(s).

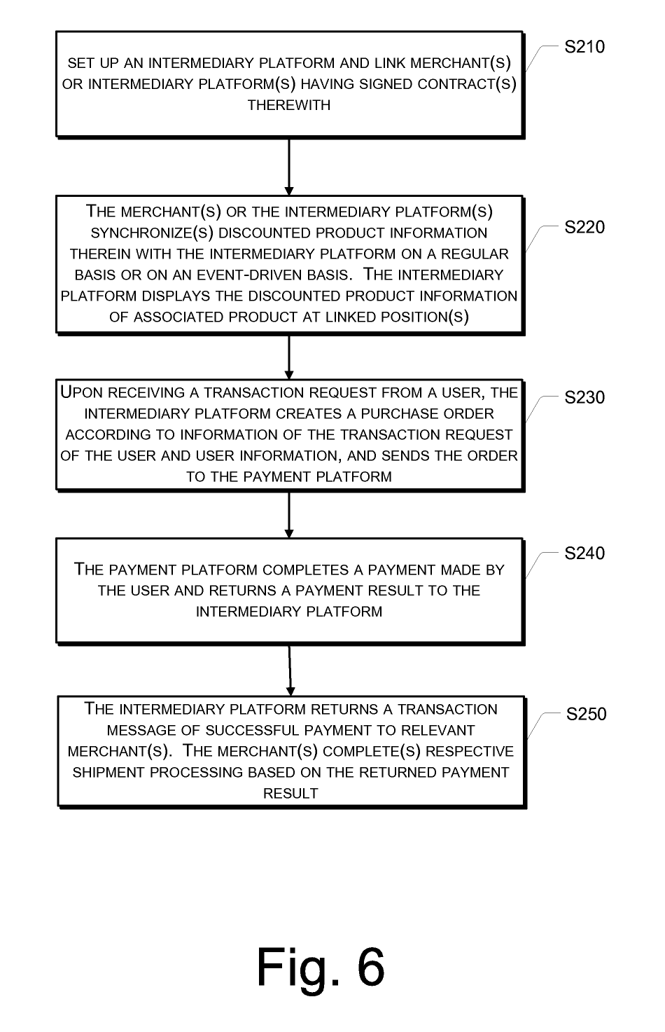

FIG. 6 shows a flow chart of a second exemplary method 600 of conducting an online transaction through an intermediary platform. The method 600 is suitable for use in an online transaction platform that is connected with a user, a payment platform, and a merchant through the Internet.

At block S210, an intermediary platform is provided, and link between the intermediary platform and merchants with which a contractual relationship exists is established.

At block S220, the merchant or the intermediary platform synchronizes product discount information to be displayed on the intermediary platform on a regular basis or on an event-triggered basis. The intermediary platform then displays the product discount information at predetermined linked position(s).

At block S230, upon receiving a transaction request from a user, the intermediary platform creates a purchase order according to information contained in the transaction request and user information, and sends the purchase order to the payment platform.

At block S240, the payment platform completes the payment made by the user and returns a payment result to the intermediary platform.

At block S250, the intermediary platform returns a transaction message of successful payment to relevant merchant. The merchant completes the shipment of the purchased product thereafter, based on the returned payment result.

Furthermore, the payment platform regularly performs profit-sharing operations with the intermediary platform according to predetermined profit-sharing ratio(s).

In one embodiment, after receiving from a user a request of logging onto the intermediary platform using a username registered with the payment platform, the intermediary platform sends the request to the payment platform and permits the user's login only upon successful verification by the payment platform. When sending a request of purchase order to the payment platform, the intermediary platform includes information of the username of the user that is registered with the payment platform. Upon receiving a payment result, the merchant obtains user information which includes a shipping address of the user from the payment result and completes delivery.

Described above are only a few exemplary embodiments of the present disclosure, and the present disclosure is not limited to those embodiments. Any modifications based on the present disclosure made by an ordinarily skilled person in the art should be considered to fall within the scope of the claims of the present disclosure and their equivalents.

What is claimed is:

1. A system of conducting online transactions, the system comprising:
an intermediary platform that includes an intermediary platform server and an intermediary platform database,
wherein the intermediary platform server comprises:
a synchronous processing unit configured to receive information of a product from a merchant selling the product, and cause the information of the product of the merchant to be displayed at a predetermined linked position in a user interface;
a transaction request processing unit configured to receive a transaction request to purchase the product from a user, send the transaction request to the merchant, and receive a transaction result from the merchant; and
an interaction unit configured to establish communications with the merchant and the user, and
wherein the intermediary platform database comprises:
a merchant information storage unit configured to store contact information of the merchant and a correlation between the information of the product of the merchant and the merchant; and
a transaction information storage unit configured to store information of a transaction, the information of the transaction including one or more of merchant information, user information, product information, transaction result information of the transaction, or a combination thereof.

2. The system of claim 1, wherein the intermediary platform server further comprises:
a payment platform processing unit coupled to the transaction request processing unit, the payment platform processing unit configured to send the transaction request to a payment platform and receive a payment feedback from the payment platform.

3. The system of claim 1, wherein the intermediary platform server further comprises:
a registered payment platform user processing unit configured to receive a login request from a second user for logging onto the intermediary platform, the login request including a username registered in a payment platform, the registered payment platform user processing unit further configured to send the login request to the payment platform and permit the second user to log onto the intermediary platform in response to successful verification of the second user by the payment platform.

4. The system of claim 1 further comprising:
a payment platform that includes a payment platform server and a payment platform database,
wherein the payment platform server comprises:
a user processing unit configured to receive a user identity request including at least one of a user registration or a user login, and
wherein the payment platform database comprises:
a user information storage unit configured to store correlations among a plurality of user characteristics with a plurality of users, the user characteristics correlated with a respective user including a username, a password, user identity information, a user address, and a payment account of the respective user.

5. The system of claim 4, wherein the payment platform server further comprises:
an intermediary platform transaction request processing unit configured to receive the transaction request from the intermediary platform, the intermediary platform transaction request processing unit further configured to recognize the transaction request to be the same as a separate transaction request received from the merchant based on a serial trading number and send the transaction result to the intermediary platform.

6. The system of claim 4, wherein the payment platform server further comprises:
a profit-sharing unit configured to perform profit-sharing operations with the intermediary platform according to a predetermined profit-sharing setting.

7. A system of conducting online transactions, the system comprising:
an intermediary platform that includes an intermediary platform server and an intermediary platform database,
wherein the intermediary platform server comprises:
a synchronous processing unit configured to receive information of a product from a merchant selling the product, and cause the information of the product to be displayed at a predetermined linked position in a user interface;
a transaction request processing unit configured to receive a transaction request to purchase the product from a user and generate a purchase order in response to receiving the transaction request;
a payment platform processing unit configured to send the purchase order to a payment platform and receive a payment result from the payment platform;
a merchant processing unit coupled to the payment platform processing unit, the merchant processing unit configured to send a transaction message of successful payment to the merchant; and
an interaction unit configured to establish communications with the merchant and the user, and
wherein the intermediary platform database comprises:
a merchant information storage unit configured to store contact information of the merchant and a correlation between the information of the product and the merchant; and
a transaction information storage unit configured to store information of a transaction, the information of the transaction including one or more of merchant information, user information, product information, transaction result information of the transaction, or a combination thereof.

8. The system of claim 7, wherein the intermediary platform server further comprises:
a registered payment platform user processing unit configured to receive a login request from a second user for logging onto the intermediary platform, the login request including a username registered in a payment platform, the registered payment platform user processing unit further configured to send the login request to the payment platform and permit the second user to log onto the intermediary platform in response to successful verification of the second user by the payment platform.

9. The system of claim 7 further comprising:
a payment platform that includes a payment platform server and a payment platform database,
wherein the payment platform server comprises:
a user processing unit configured to receive a user identity request including at least one of a user registration or a user login, and
wherein the payment platform database comprises:
a user information storage unit configured to store correlations among a plurality of user characteristics with a plurality of users, the user characteristics correlated with a respective user including a username, a password, user identity information, a user address, and a payment account of the respective user.

10. The system of claim 9, wherein the payment platform server further comprises:
a profit-sharing unit configured to perform profit-sharing operations with the intermediary platform according to a predetermined profit-sharing setting.

11. A method of conducting an online transaction through an intermediary platform, the method comprising:
receiving product information of a product from a merchant selling the product;
causing the product information to be displayed at a predetermined position in a user interface;
receiving a transaction request to purchase the product from a user;
sending information related to the transaction request to the merchant;
receiving a payment result from a payment platform indicative of a payment by the user to purchase the product;
receiving a login request from the user, the login request including a username of the user that is registered with the payment platform;
sending the login request to the payment platform; and
permitting the user to login in response to successful verification of the user by the payment platform.

12. The method of claim 11 further comprising:
sending the username of the user that is registered with the payment platform to the merchant.

13. The method of claim 11 further comprising:
sending the transaction request to the merchant, the transaction request including a serial trading number.

14. The method of claim 11 further comprising:
sending the transaction request to the payment platform, the transaction request including a serial trading number.

15. The method of claim 14 further comprising:
receiving a payment result from the payment platform in response to the payment platform determining the payment platform verifying the transaction request based on the serial trading number.

16. The method of claim 11 further comprising:
receiving a profit-sharing result from the payment platform upon the payment platform performing profit-sharing operations based on a predetermined profit-sharing setting.

17. A method of conducting an online transaction through an intermediary platform, the method comprising:
establishing a communication link between the intermediary platform and a merchant;
receiving product information of a product from the merchant;
causing the product information to be displayed at a predetermined position in a user interface;
synchronizing the displayed product information with updates to the product information from the merchant;
receiving a transaction request to purchase the product from a user;
creating a purchase order using information related to the transaction request;
receiving a payment result indicative of a successful payment by the user from a payment platform in response to the payment platform receiving a payment from the user; and
sending to the merchant a transaction message indicative of the successful payment by the user.

18. The method of claim 17 further comprising:
sending the transaction request to at least one of the merchant or the payment platform, the transaction request including a serial trading number.

19. The method of claim 17 further comprising:
receiving a login request from the user, the login request including a username of the user that is registered with the payment platform;
sending the login request to the payment platform; and
permitting the user to login in response to successful verification of the user by the payment platform.

20. The method of claim 17 further comprising:
sending the username of the user that is registered with the payment platform to the merchant.
